(19) United States
(12) Patent Application Publication
(10) Pub. No.: US 2024/0329596 A1
(43) Pub. Date: Oct. 3, 2024

(54) IMAGE FORMING SYSTEM

(71) Applicant: FUJIFILM Business Innovation Corp., Tokyo (JP)

(72) Inventors: Shunsuke YAMASAKI, Kanagawa (JP); Yuta SHIMATATE, Kanagawa (JP)

(73) Assignee: FUJIFILM Business Innovation Corp., Tokyo (JP)

(21) Appl. No.: 18/355,846

(22) Filed: Jul. 20, 2023

(30) Foreign Application Priority Data
Mar. 27, 2023 (JP) 2023-050259

(51) Int. Cl. G03G 21/20; G03G 15/20

(52) U.S. Cl. CPC G03G 21/206; G03G 15/2021; G03G 2221/1645

(57) ABSTRACT

An image forming system includes: a transfer unit that transfers an image formed of a thermally fusible image-forming material to a medium that moves; a thermal fixing unit disposed downstream of the transfer unit in a moving direction in which the medium moves, the thermal fixing unit fixing the image on the medium by at least heating the image; and a cooling unit that cools a spatial region between the transfer unit and the thermal fixing unit. The cooling unit has suction openings through which outside air is taken into the spatial region between the transfer unit and the thermal fixing unit from both sides of the spatial region in a crossing direction crossing the moving direction of the medium. The cooling unit includes an exhaust unit that draws in and discharges air in the spatial region such that an amount of air drawn in a central region in the crossing direction of the medium is greater than an amount of air drawn in regions adjacent to ends in the crossing direction of the medium.

### CROSS-REFERENCE TO RELATED APPLICATIONS

This application is based on and claims priority under 35 USC 119 from Japanese Patent Application No. 2023-050259 filed Mar. 27, 2023.

### Background

### (i) Technical Field

The present disclosure relates to an image forming system.

### (ii) Related Art

Japanese Unexamined Patent Application Publication No. 2001-235997 (see embodiments of the disclosure and FIG. 9) describes an example of an image forming system of a related art.

Japanese Unexamined Patent Application Publication No. 2001-235997 describes an image forming apparatus in which a layered duct and a fan for sucking outside air are disposed in a body of the image forming apparatus at a location between a fixing device and processing units for forming an image. Two types of air layers, which are an air circulation layer and an air retaining layer, are provided to efficiently cool the inside of the apparatus and thermally insulate a fixing unit.

### SUMMARY

Aspects of non-limiting embodiments of the present disclosure relate to an image forming system capable of reducing the temperature around a transfer unit at a low flow rate without damaging an unfixed image on a medium that has not yet reached a thermal fixing unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a transfer unit that transfers an image formed of a thermally fusible image-forming material to a medium that moves; a thermal fixing unit disposed downstream of the transfer unit in a moving direction in which the medium moves, the thermal fixing unit fixing the image on the medium by at least heating the image; and a cooling unit that cools a spatial region between the transfer unit and the thermal fixing unit, wherein the cooling unit has suction openings through which outside air is taken into the spatial region between the transfer unit and the thermal fixing unit from both sides of the spatial region in a crossing direction crossing the moving direction of the medium, and wherein the cooling unit includes an exhaust unit that draws in and discharges air in the spatial region such that an amount of air drawn in a central region in the crossing direction of the medium is greater than an amount of air drawn in regions adjacent to ends in the crossing direction of the medium.

### BRIEF DESCRIPTION OF THE DRAWINGS

Exemplary embodiments of the present disclosure will be described in detail based on the following figures, wherein:

FIG. 1A illustrates an overview of an exemplary embodiment of an image forming system to which the present disclosure is applied;

FIG. 1B is a planar illustration of the image forming system illustrated in FIG. 1A;

FIG. 2 illustrates the overall structure of an image forming apparatus as an image forming system according to a first exemplary embodiment;

FIG. 3 illustrates an apparatus module including a second transfer device and a fixing device of the image forming apparatus according to the first exemplary embodiment;

FIG. 4 is a sectional view of the apparatus module illustrated in FIG. 3 taken along line IV-IV;

FIG. 5 is a perspective view of the fixing device in the direction of arrow V in FIG. 4; FIG. 6 is a perspective view in the direction of arrow VI in FIG. 4;

FIG. 7 is a schematic top plan view of a cooling mechanism mounted in the apparatus module illustrated in FIG. 3;

FIG. 8 illustrates an example of an exhaust duct included in an exhaust mechanism illustrated in FIG. 7;

FIG. 9 is a plan view of the exhaust duct illustrated in FIG. 8 in the direction of arrow IX;

FIG. 10A is a schematic diagram illustrating an example of intake openings in the exhaust duct according to the first exemplary embodiment;

FIGS. 10B and 10C illustrate other examples of intake openings;

FIG. 11 illustrates flows of air caused by the cooling mechanism according to the first exemplary embodiment;

FIG. 12 illustrates a cooling effect provided by the cooling mechanism according to the first exemplary embodiment;

FIG. 13 illustrates flows of air caused by a cooling mechanism according to a comparative example;

FIG. 14 illustrates a relevant part of a cooling mechanism according to a second exemplary embodiment; and

FIG. 15 illustrates a relevant part of a cooling mechanism according to a third exemplary embodiment.

### DETAILED DESCRIPTION

### Overview of Exemplary Embodiment

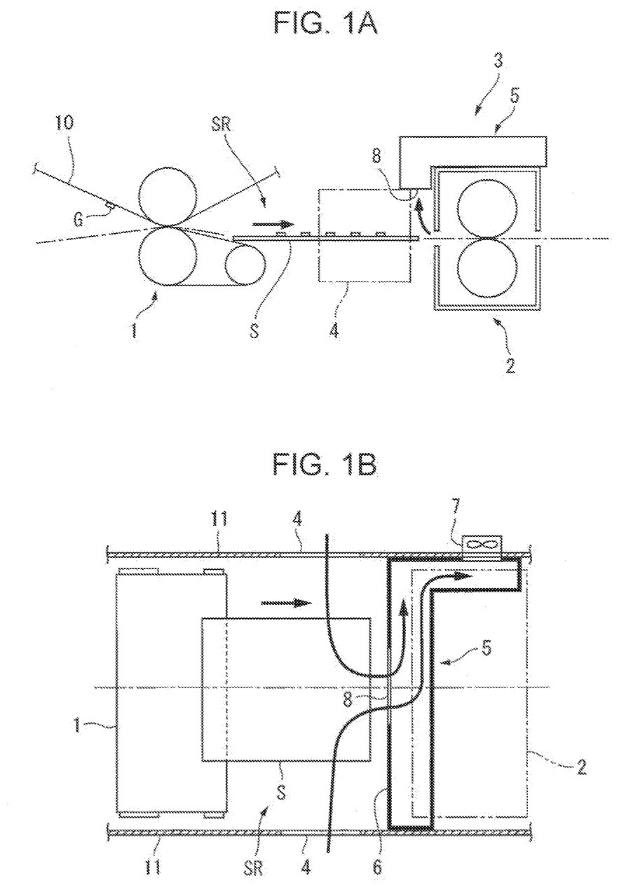

FIGS. 1A and 1B illustrate an overview of an exemplary embodiment of an image forming system to which the present disclosure is applied;

Referring to FIGS. 1A and 1B, an image forming system includes a transfer unit 1 that transfers an image G formed of a thermally fusible image-forming material to a medium S that moves; a thermal fixing unit 2 disposed downstream of the transfer unit 1 in a moving direction in which the medium S moves, the thermal fixing unit 2 fixing the image G on the medium S by at least heating the image G; and a cooling unit 3 that cools a spatial region SR between the transfer unit 1 and the thermal fixing unit 2. The cooling unit 3 has suction openings 4 through which outside air is taken into the spatial region SR between the transfer unit 1 and the thermal fixing unit 2 from both sides of the spatial region SR in a crossing direction crossing the moving direction of the medium S. The cooling unit 3 includes an exhaust unit 5 that draws in and discharges air in the spatial region SR such that an amount of air drawn in a central region in the crossing direction of the medium S is greater than an amount of air drawn in regions adjacent to the ends in the crossing direction of the medium S.

In the above-described technical configuration, the transfer unit 1 may be various units that transfer the image G formed of a thermally fusible image-forming material (for example, toner) by, for example, a roller transfer method or a belt transfer method. Referring to FIG. 1A, an image carrier 10 facing the transfer unit 1 holds the image G and transports the image G to a transfer position of the transfer unit 1.

The thermal fixing unit 2 may be any contact or non-contact unit that fixes the image G by at least heating the image G. The thermal fixing unit 2, of course, includes a unit that applies pressure in addition to heat.

The cooling unit 3 may be any unit that cools the spatial region SR between the transfer unit 1 and the thermal fixing unit 2. The cooling unit 3 may include, for example, a portion in contact with an upper portion of a housing that covers the thermal fixing unit 2. Note that the cooling unit 3 is expected to reduce an increase in the temperature around the transfer unit 1 due to transmission of fixing heat generated in the thermal fixing unit 2, and the thermal fixing process of the thermal fixing unit 2 itself is not to be impeded.

The technology according to this example is effective in preventing filming, which is fixation of paper dust or an image-forming material, such as toner, on a roller of the transfer unit 1 or a belt surface due to an increase in the temperature around the transfer unit 1 due to transmission of the fixing heat.

In particular, when the distance between the transfer unit 1 and the thermal fixing unit 2 is reduced, the temperature around the transfer unit 1 is significantly increased due to the fixing heat, and therefore the above-described filming phenomenon easily occurs.

Therefore, in this example, the cooling unit 3 is required. However, when the flow rate of the cooling air is simply increased to increase the cooling performance, there is a risk that the image-forming material and the like floating in the air will be drawn in and discharged, resulting in soiling outside the apparatus.

Accordingly, in this example, structures based on factors described below are employed to reduce an increase in the temperature around the transfer unit 1 at a low flow rate.

Firstly, as illustrated in FIG. 1B, the suction openings 4 through which outside air is taken in from both sides in the crossing direction of the medium S are provided so that the outside air for cooling the spatial region SR can be easily taken into the spatial region SR. In FIG. 1B, the transfer unit 1, the thermal fixing unit 2, and other components are mounted in a housing 11.

Secondly, to efficiently remove heat from the spatial region SR, the exhaust unit 5 may have a function of drawing in and discharging the air in the spatial region SR such that an amount of air drawn in a central region in the crossing direction of the medium S is greater than an amount of air drawn in regions adjacent to the ends in the crossing direction of the medium S. Accordingly, the outside air taken in through the suction openings 4 at both sides in the crossing direction of the medium S may be caused to flow over a large region in the spatial region SR before being discharged.

From a structural point of view, the exhaust unit 5 may draw in and discharge the air in the spatial region SR such that an opening area in a central region in the crossing direction of the medium S is greater than an opening area in regions adjacent to the ends in the crossing direction of the medium S.

Typical forms of the image forming system according to the present exemplary embodiment will now be described.

As illustrated in FIGS. 1A and 1B, in a typical form, the exhaust unit 5 may include an air flow unit 6 extending in the crossing direction of the medium S and a suction unit 7 that sucks the air in the air flow unit 6 and discharges the air to the outside, and a portion of the air flow unit 6 has at least one intake opening 8 through which the air in the spatial region SR is drawn.

The air flow unit 6 may be any unit having an air flow passage element extending in the crossing direction of the medium S, and may additionally include an air flow passage element that is bent with respect to the air flow passage element extending in the crossing direction of the medium S. The suction unit 7 may be disposed in the air flow passage of the air flow unit 6 or in a communication passage that communicates with the air flow passage. The shape, number, size, etc. of the at least one intake opening 8 may be selected as appropriate as long as the conditions regarding the amount of air that is drawn or the opening area are satisfied.

Examples of forms of the intake opening 8 will now be described.

### Layout of Intake Opening

(1) The intake opening 8 is disposed within an area of projection of the suction openings 4 when the suction openings 4 are viewed from the outside in the crossing direction of the medium S.

(2) The intake opening 8 opens toward a surface of the medium S at a location above a path along which the medium S moves.

(3) Assuming that the suction unit 7 is disposed at one end of the air flow unit 6 in the crossing direction of the medium S, in a range from the center of the air flow unit 6 in the crossing direction of the medium S to the suction unit 7, the intake opening 8 is provided in the central region in the crossing direction of the medium S and is not provided in a region adjacent to the suction unit 7.

### Locations of Intake Opening

In the spatial region SR, the fixing heat is removed by media S of various sizes in a region through which the media S of various sizes pass, but is not removed by the media S in regions through which the media S do not pass. This greatly affects the increase in temperature around the transfer unit 1.

Accordingly, the intake opening 8 is to be disposed within a region having a size less than or equal to a predetermined size other than the size of a largest medium S that is used. In particular, the intake opening 8 may be disposed within a region having a size less than or equal to the size of a smallest medium S that is used.

### Size of Intake Opening

When plural intake openings 8 that are separate from each other are provided, one or more of the intake openings 8 in the central region in the crossing direction of the medium S have an opening area greater than an opening area of the other intake openings 8.

When one intake opening 8 is formed in a portion of the air flow unit 6 and when the air flow passage is partitioned by a partitioning member, such as a rib, at a location facing the intake opening 8, the partitioning member may have an opening so that a flow passage area is larger in the central region in the crossing direction of the medium S than in other regions.

The present disclosure will now be described in more detail by way of exemplary embodiments illustrated in the accompanying drawings.

### First Exemplary Embodiment

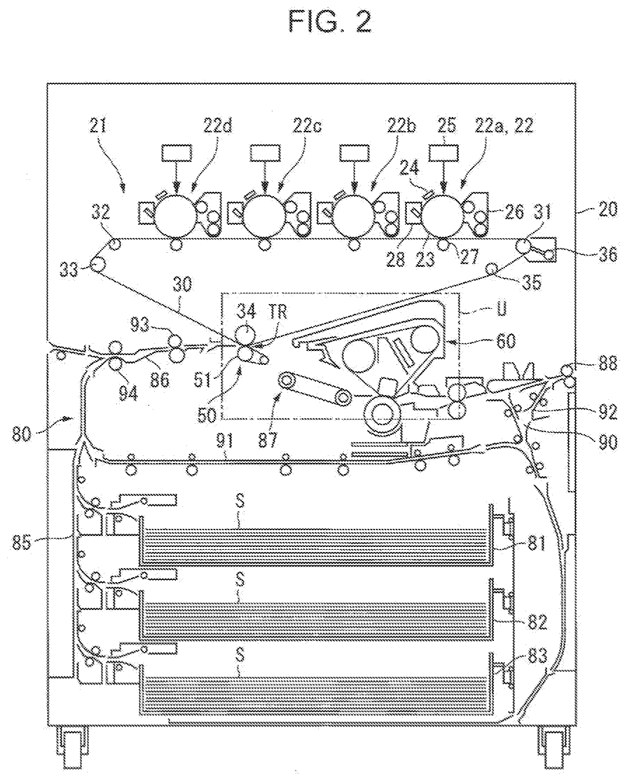

FIG. 2 illustrates the overall structure of an image forming apparatus as an image forming system according to a first exemplary embodiment.

### Overall Structure of Image Forming Apparatus

Referring to FIG. 2, the image forming apparatus basically includes, in an apparatus housing 20, an image forming engine 21 for forming, for example, images of respective color components; a medium transport system 80 that is disposed below the image forming engine 21 and transports a medium S to the image forming engine 21; and a fixing device 60 that is disposed below the image forming engine 21 and fixes the images formed by the image forming engine 21 to the medium S.

In this example, the image forming engine 21 includes image forming units 22 (specifically, 22a to 22d) that form images in general colors corresponding to respective color components (yellow (Y), magenta (M), cyan (C), and black (K) in the present exemplary embodiment); a belt-shaped intermediate transfer body 30 that holds the images of respective color components formed by the image forming units 22 and successively transferred thereto in a first transfer process; and a second transfer device (collective transfer device) 50 that transfers (collectively transfers) the images of respective color components that have been transferred to the intermediate transfer body 30 to the medium S (paper sheet or film) in a second transfer process.

### Image Forming Unit

In the present exemplary embodiment, the image forming units 22 (22a to 22d) include respective drum-shaped photoconductors 23, and each photoconductor 23 is surrounded by a charging device 24, such as a corotron or a transfer roller, that charges the photoconductor 23; an exposure device 25, such as a laser scanner, that writes an electrostatic latent image on the charged photoconductor 23; a developing device 26 that develops the electrostatic latent image written on the photoconductor 23 with toner of a corresponding one of Y, M, C, and K color components; a first transfer device 27, such as a transfer roller, that transfers the toner image on the photoconductor 23 to the intermediate transfer body 30; and a photoconductor cleaning device 28 removes residual toner on the photoconductor 23.

### Intermediate Transfer Body

The intermediate transfer body 30 is wrapped around plural stretching rollers (five stretching rollers in the present exemplary embodiment) 31 to 35, and the stretching roller 31, for example, serves as a drive roller that is driven by a drive motor (not illustrated) and that rotates the intermediate transfer body 30. An intermediate-transfer-body cleaning device 36 for removing residual toner on the intermediate transfer body 30 after the second transfer process is provided on the intermediate transfer body 30 at a location at which the intermediate transfer body 30 is wrapped around the stretching roller 31.

### Second Transfer Device (Collective Transfer Device)

As illustrated in FIGS. 2 to 4, the second transfer device (collective transfer device) 50 includes, for example, a transfer belt module 51 facing the stretching roller 34 on the intermediate transfer body 30. In this example, the transfer belt module 51 includes a pair of stretching rollers 52 and 53 and a transfer belt 54 wrapped around the stretching rollers 52 and 53. The stretching roller 52, which is positioned at an upstream end in a transport direction (corresponding to a moving direction) in which the medium S is transported, serves as a transfer roller 55 pressed against the stretching roller 34 on the intermediate transfer body 30 with the transfer belt 54 disposed therebetween, and the stretching roller 34 on the intermediate transfer body 30 serves as a counter roller 56 functioning as a counter electrode for the transfer roller 55 (stretching roller 52).

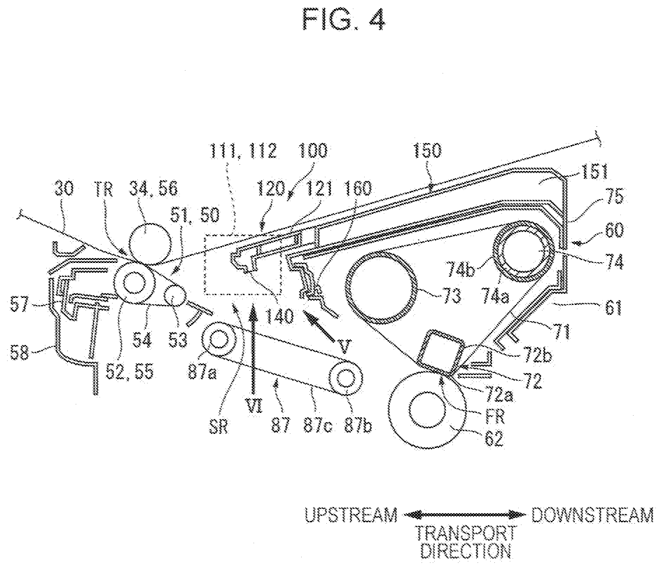

Referring to FIG. 4, a belt cleaning device 57 cleans the transfer belt 54, and a module housing 58 accommodates components of the transfer belt module 51.

The transfer roller 55 is formed by covering a metal shaft with an elastic layer made of foamed urethane rubber or EPDM in which carbon black or the like is mixed, and the transfer belt 54 is made of, for example, polyimide resin. The counter roller 56, which also serves as the stretching roller 34, receives a transfer voltage from a transfer power supply (not illustrated) through a conductive feeding roller (not illustrated), and the transfer roller 55 is grounded. Therefore, a transfer electric field is formed between the transfer roller 55 and the counter roller 56, and a contact region (nip region) between the transfer belt 54 wrapped around the transfer roller 55 and the intermediate transfer body 30 serves as a second transfer region (collective transfer region) TR.

Although the second transfer device 50 includes the transfer belt module 51, the second transfer device 50 is not limited to this, and may, of course, be configured such that the transfer belt 54 is omitted and that the transfer roller 55 is pressed against the counter roller 56 on the intermediate transfer body 30.

### Fixing Device

In this example, the fixing device 60 is an example of a thermal fixing unit that thermally fixes an unfixed image by at least heating the image, and includes a fixing belt module 61 and a pressing roller 62 that faces and is pressed against the fixing belt module 61.

In this example, the fixing belt module 61 includes a fixing belt 71, a load-receiving member 72, a driving support roller 73, and a heating support roller 74. The fixing belt 71 rotates and is made of a heat resisting material. The load-receiving member 72 faces the pressing roller 62 with the fixing belt 71 disposed therebetween, and forms a fixing region FR, in which the medium S is nipped and transported, between the load-receiving member 72 and the fixing belt 71 receiving load from the pressing roller 62. The fixing belt 71 is rotatably wrapped around the driving support roller 73 at a location separate from and upstream of the fixing region FR of the fixing belt 71 in a moving direction of the fixing belt 71. The driving support roller 73 receives a driving force from a drive source (not illustrated) and drives the fixing belt 71. The fixing belt 71 is rotatably wrapped around the heating support roller 74 at a location separate from and downstream of the fixing region FR of the fixing belt 71 in the moving direction of the fixing belt 71. The heating support roller 74 is in contact with the fixing belt 71 and heats the fixing belt 71. The components of the fixing belt module 61 are accommodated in a module housing 75.

### Fixing Belt

In this example, the fixing belt 71 includes a base made of a heat-resistant resin material, such as polyimide (PI) resin, and an elastic layer made of silicone rubber or the like and a release layer made of a fluorine-based resin are provided on a surface of the base. The fixing belt 71 generally has a low thermal conductivity in the thickness and planar directions.

### Load-Receiving Member

In this example, the load-receiving member 72 includes a plate-shaped pressing pad 72a (made of, for example, SUS or liquid crystal polymer) serving as a plate-shaped receiving member in contact with a back surface of the fixing belt 71. The pressing pad 72a is held by a pad holder 72b, and the pressing roller 62 facing the pressing pad 72a is pressed against a front surface of the fixing belt 71. In this example, the pressing roller 62 includes a metal roller covered with a layer of an elastic material, such as urethane rubber, and presses the fixing belt 71 against the pressing pad 72a to form the predetermined fixing region FR, so that the medium S is nipped and transported in the fixing region FR as the fixing belt 71 is moved.

### Driving Support Roller

The driving support roller 73 is disposed downstream of the heating support roller 74 in the moving direction of the fixing belt 71, and there is a possibility that the thermal energy of the fixing belt 71 heated by the heating support roller 74 will be reduced at a contact region between the fixing belt 71 and the driving support roller 73. Therefore, to reduce heat loss through the driving support roller 73, a thermally insulating protective layer (not illustrated) or the like that provides effective thermal insulation may be provided on a surface of the driving support roller 73.

### Heating Support Roller

In this example, as illustrated in FIG. 4, the heating support roller 74 includes a metal roller 74a composed of a cylinder made of a metal as a base and a heating resistor layer 74b provided on a peripheral surface of the metal roller 74a with an insulating layer (not illustrated) interposed therebetween, and the heating resistor layer 74b is covered with a protective layer (not illustrated).

Although the fixing device 60 is structured such that the fixing belt 71 is heated by the heating support roller 74 in this example, a heater (not illustrated) that heats the load-receiving member 72 or the driving support roller 73 may be provided in the load-receiving member 72 or the driving support roller 73 in place of or in addition to the heating support roller 74.

Although the fixing device 60 employs a fixing belt method in which the heating support roller 74 is used, the fixing device 60 is not limited to this, and may employ any appropriate method, such as a roller-pair fixing method in which a heating fixing roller and a pressing fixing roller are used or a fixing belt method based on an electromagnetic induction heating method.

### Medium Transport System

The medium transport system 80 includes plural medium supply containers (three medium supply containers in this example) 81, 82, and 83. The medium S supplied from one of the medium supply containers 81, 82, and 83 is transported from a vertical transport path 85 extending substantially vertically to the second transfer region TR along a horizontal transport path 86 extending substantially horizontally. After that, the medium S holding the image G transferred thereto is transported along a transport belt 87 to the fixing region FR of the fixing device 60, and output to a medium receiver (not illustrated) provided on a side of the apparatus housing 20 by output rollers 88.

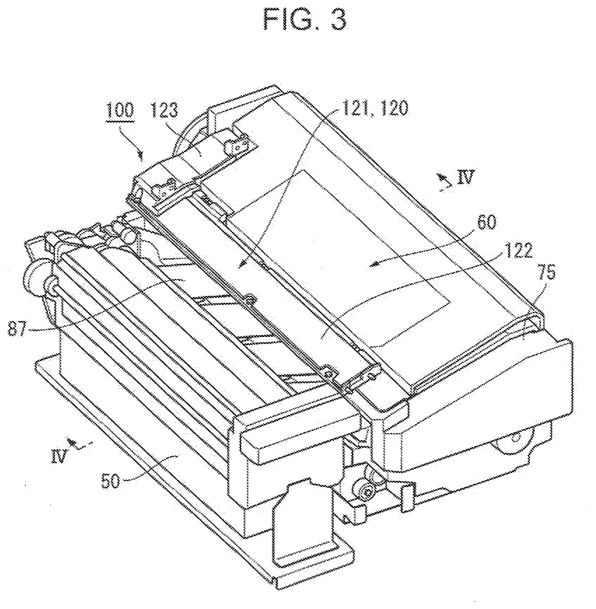

In this example, the transport belt 87 is required to transport the medium S holding the unfixed image G while holding the medium S at the back surface of the medium S. Therefore, referring to FIGS. 3 and 4, a suction belt member 87c capable of performing air suction is rotatably wrapped around stretching rollers 87a and 87b, and an air suction force is applied to the space inside the suction belt member 87c by a vacuum source (not illustrated) so that the medium S is transported while being held by the suction belt member 87c by suction.

The medium transport system 80 also includes a branching transport path 90 that branches downward from the horizontal transport path 86 at a location downstream of the fixing device 60 in the medium transport direction and that is capable of reversing the medium S. The medium S reversed by the branching transport path 90 is transported along a returning transport path 91 and returned to the horizontal transport path 86 from the vertical transport path 85, and then the image G is transferred to the back surface of the medium S in the second transfer region TR. Then, the medium S is transported through the fixing device 60 and output to the medium receiver (not illustrated). The branching transport path 90 is provided with a branching-and-returning transport path 92 that branches from the branching transport path 90 at an intermediate position and that transports the reversed medium S toward the medium receiver (not illustrated).

The medium transport system 80 also includes position adjustment rollers 93 serving as a positioning transport unit that supplies the medium S to the second transfer region TR after adjusting the position of the medium S, and an appropriate number of transport rollers 94 provided on the transport paths 85, 86, 90, 91, and 92. A manual feed medium supplier (not illustrated) that allows the media to be manually supplied toward the horizontal transport path 86 is provided on the apparatus housing 20 at a side opposite to the side at which the medium receiver is provided.

### Removably Attachable Unit

As illustrated in FIGS. 2 and 3, the transfer belt module 51 of the second transfer device 50, the transport belt 87, and the fixing device 60 are integrated together as a removably attachable unit U. The removably attachable unit U is movable relative to the apparatus housing 20 in a front-rear direction along guide rails (not illustrated) or the like and is capable of being pulled out of the apparatus housing 20 in a forward direction.

In this example, the removably attachable unit U is pulled out of the apparatus housing 20 in the event of, for example, a jam in which the medium S is stuck at the transport belt 87 or the fixing device 60, or for maintenance of the image forming apparatus.

### Basic Structure of Cooling Mechanism

In the present exemplary embodiment, as illustrated in FIG. 4, a cooling mechanism 100 is provided as a cooling unit for cooling the spatial region SR between the second transfer device 50 and the fixing device 60.

In this example, since the second transfer device 50 includes the transfer belt module 51 extending toward the fixing device 60 beyond the second transfer region TR and the fixing device 60 includes the fixing belt module 61 projecting toward the second transfer device 50 from the fixing region FR, the second transfer device 50 and the fixing device 60 are close each other. Therefore, the fixing heat from the fixing device 60 easily causes an increase in the temperature around the second transfer device 50, and the cooling mechanism 100 is required to reliably cool the spatial region SR.

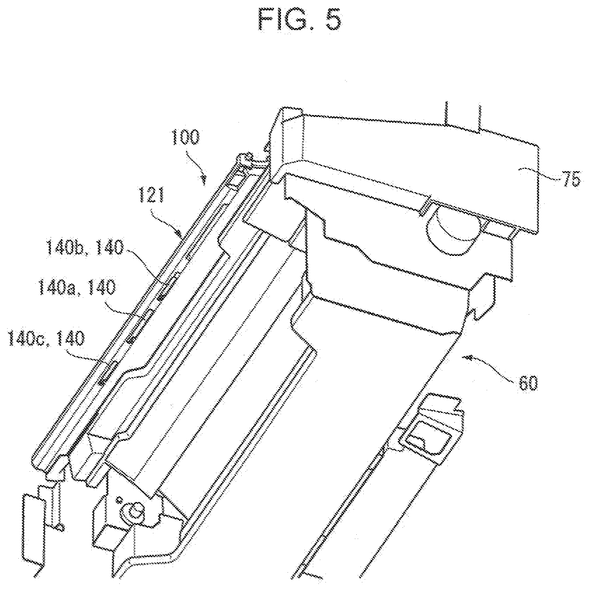

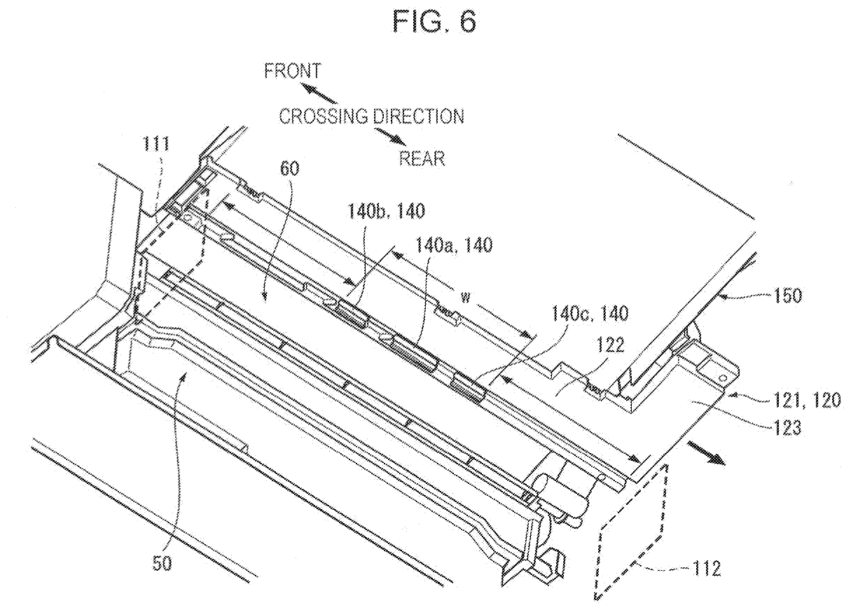

In this example, to satisfy the above-described requirement, as illustrated in FIGS. 4 to 7, the cooling mechanism 100 has suction openings 111 and 112 through which outside air is taken into the spatial region SR from both sides in a crossing direction crossing the transport direction of the medium S, and includes an exhaust mechanism 120 serving as an exhaust unit that draws in and discharges the air in the spatial region SR.

### Suction Openings

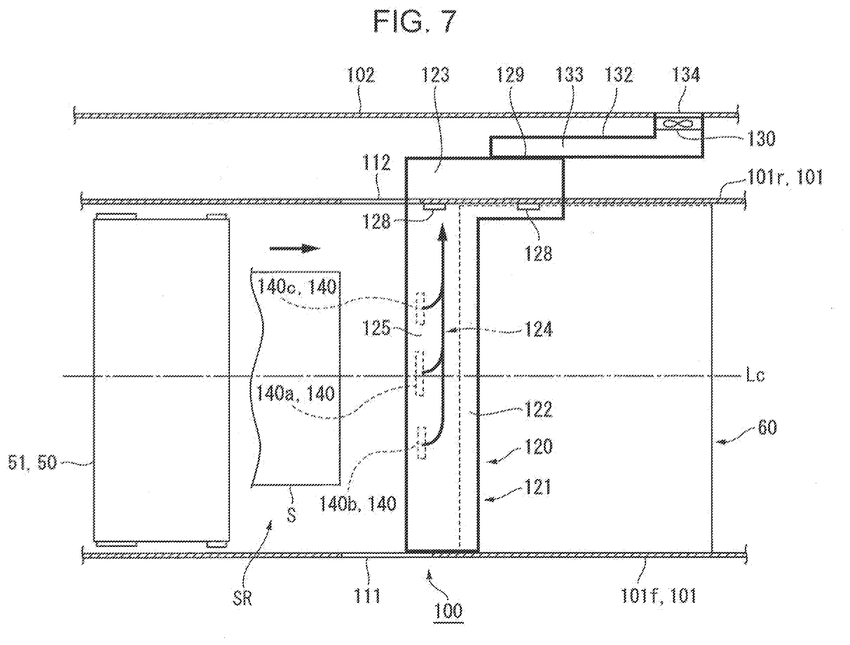

In this example, as illustrated in FIGS. 4 and 7, the spatial region SR is partitioned by housing frames 101, which are portions of the apparatus housing 20 positioned at both sides in the crossing direction crossing the transport direction of the medium S. The housing frames 101 include a front frame 101f positioned at the front in the crossing direction and a rear frame 101r positioned at the rear in the crossing direction.

In this example, the housing frames 101 (specifically, the front frame 101f and the rear frame 101r) positioned on both sides of the spatial region SR have substantially rectangular suction openings 111 and 112. The suction openings 111 and 112 are disposed between the module housing 58 of the transfer belt module 51 and a module housing 75 of the fixing belt module 61 in a region above a transport surface of the transport belt 87 along which the medium S is transported.

Although the suction openings 111 and 112 are substantially rectangular in this example, the shape of the suction openings 111 and 112 is not limited to this, and may be a shape including multiple slits extending vertically or horizontally or a non-rectangular shape, such as a circular shape, an elliptical shape, or a polygonal shape. The positions of the suction openings 111 and 112 are also not limited to the above-described positions, and may be changed as appropriate.

### Exhaust Mechanism

### Basic Structure of Exhaust Mechanism

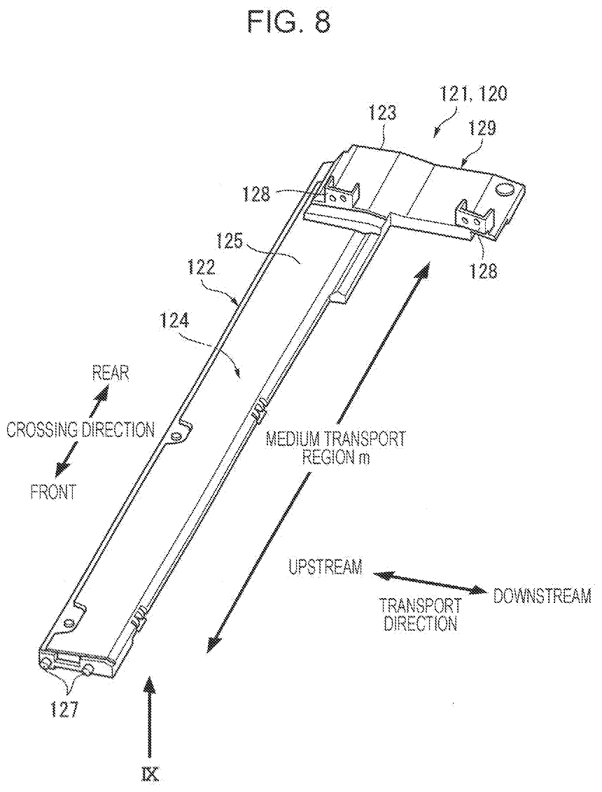

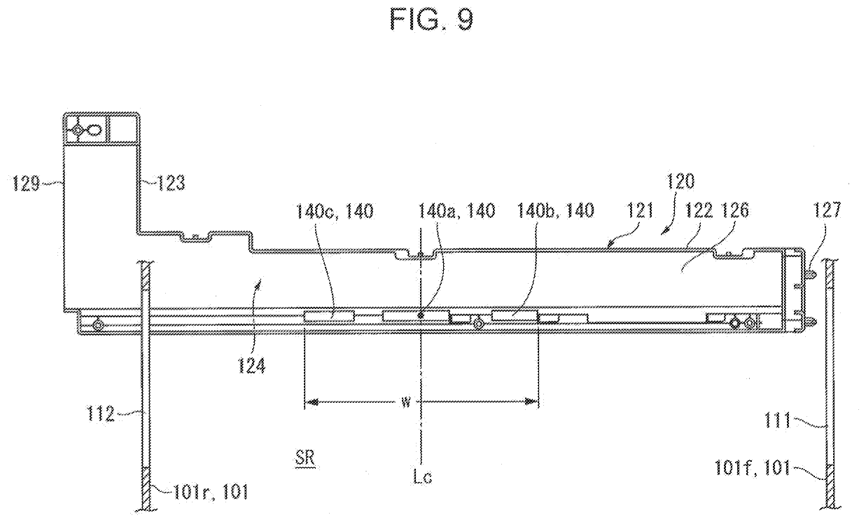

In the present exemplary embodiment, as illustrated in FIGS. 3 to 9, the exhaust mechanism 120 includes an exhaust duct 121 serving as an air flow unit extending in the crossing direction of the medium S and an exhaust fan 130 serving as a suction unit that sucks air in the exhaust duct 121 and discharges the air to the outside, and a portion of the exhaust duct 121 has intake openings 140 through which the air in the spatial region SR is drawn.

### Exhaust Duct

In this example, the exhaust duct 121 projects into the spatial region SR beyond the module housing 75 of the fixing belt module 61 of the fixing device 60.

In this example, the exhaust duct 121 includes a long section 122 extending in the crossing direction of the medium S and a bent section 123 extending downstream in the transport direction of the medium S from a rear end of the long section 122. The overall shape of the exhaust duct 121 including the long section 122 and the bent section 123 is flat in the up-down direction, and an air flow passage 124 through which air flows is formed in the exhaust duct 121.

In this example, the length of the long section 122 in the longitudinal direction, which corresponds to the crossing direction, is longer than the length of a medium transport region m through which the medium S is transported in the fixing device 60. The bent section 123 is disposed behind the medium transport region m in the crossing direction.

As illustrated in FIGS. 7 to 9, the exhaust duct 121 has an upper surface portion 125 and a lower surface portion 126 that face each other in the up-down direction with the air flow passage 124 provided therebetween. In this example, the upper surface portion 125 extends along the intermediate transfer body 30, and the lower surface portion 126 faces the transport belt 87 with a gap therebetween.

The exhaust duct 121 includes positioning pins 127 serving as positioning portions at the front end of the long section 122 in the longitudinal direction and attachment brackets 128 serving as attachment portions on the upper surface portion 125 of the bent section 123. The exhaust duct 121 is attached by inserting the positioning pins 127 into positioning portions provided on one of the housing frames 101 (front frame 101f in this example), which is a portion of the apparatus housing 20, and fastening the attachment brackets 128 to another one of the housing frames 101 (rear frame 101r in this example) with screws or the like.

### Exhaust Fan

In this example, a rear surface of the rear frame 101r is covered with a rear cover 102 with a space therebetween. A communication duct 132, which communicates with the exhaust duct 121, is provided in the space between the rear frame 101r and the rear cover 102. The communication duct 132 has an air flow passage 133, one end of which is connected to a communication port 129 formed in the bent section 123 of the exhaust duct 121 and the other end of which is connected to an exhaust port 134 formed in the rear cover 102.

In this example, the exhaust fan 130 is disposed at any location in the communication duct 132, for example, near the exhaust port 134, so that the air in the exhaust duct 121 is sucked through the communication duct 132 and discharged through the exhaust port 134.

The air in the exhaust duct 121 contains powder, such as paper dust and toner serving as an image-forming material, floating therein, and therefore the communication duct 132 may be provided with a filter for cleaning the air so that the powder floating in the air is not discharged to the outside of the apparatus.

### Intake Openings

In this example, as illustrated in FIGS. 3 to 9, the exhaust duct 121 has plural intake openings 140 (three intake openings 140a to 140c in this example) in the lower surface portion 126 of the long section 122. The intake openings 140 face the spatial region SR, and air is drawn in therethrough.

In this example, the intake openings 140 are provided at an upstream end of the lower surface portion 126 of the long section 122 in the transport direction of the medium S, and are arranged next each other with gaps therebetween in a central region in the crossing direction of the medium S.

Thus, each of the intake openings 140 opens downward in the direction of gravity. Here, the expression “downward in the direction of gravity” means that the air flow passage 124 is visible through the intake openings 140 when the exhaust duct 121 is viewed from below in the direction of gravity.

In this example, each intake opening 140 is formed in the shape of, for example, a rectangular slit. However, the shapes of the intake openings 140 are not limited to this, and the intake openings 140 may have any shape as long as air can be drawn in therethrough.

The intake openings 140 are to be disposed at least in a central region in the crossing direction of the medium S.

The expression “disposed in the central region in the crossing direction of the medium S” has the following meaning.

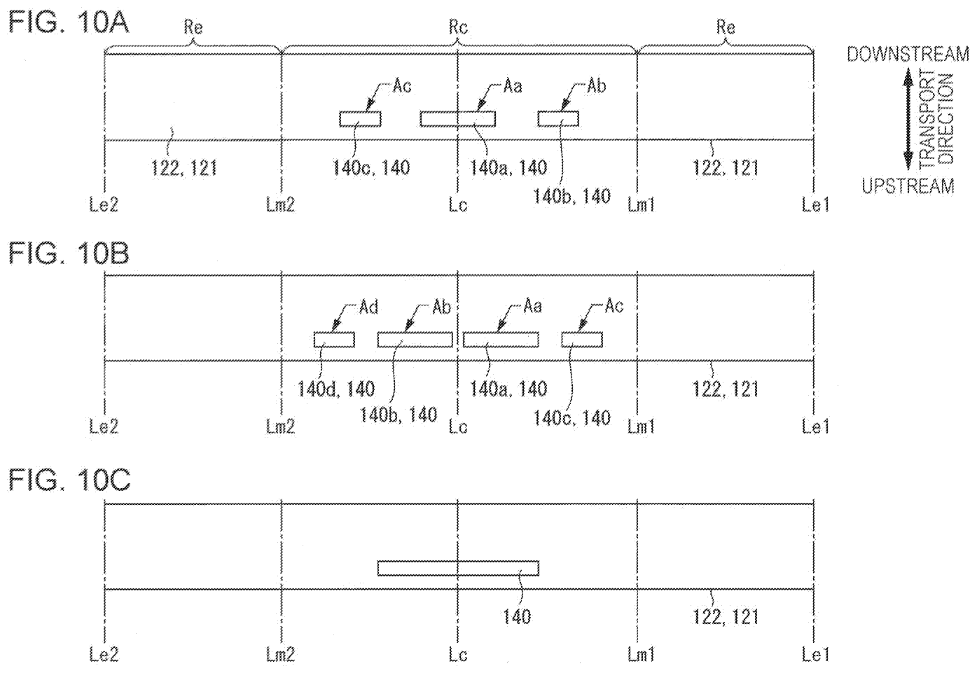

For example, referring to FIG. 10A, assume that the central position in the crossing direction of the medium S is Lc, the end positions of the long section 122 of the exhaust duct 121 in the crossing direction of the medium S are Le (specifically, Le1 and Le2), the midpoints between Lc and Le are Lm (specifically, Lm1 and Lm2), a central region in the crossing direction of the medium S is Rc (specifically, the region between Lm1 and Lm2 including Lc), and regions adjacent to the ends in the crossing direction of the medium S are Re (specifically, regions from Le1 to Lm1 and from Le2 to Lm2). In this case, an area occupied by the intake openings 140 (140a to 140c in this example) is larger in the region Rc than in the regions Re.

In this example, the intake openings 140 are disposed exclusively in the region Rc, and are not disposed in the regions Rc.

Although the intake openings 140 are not disposed in the regions Re in this example, the intake openings 140 may be partially disposed in the regions Rc.

In this example, as illustrated in FIG. 10A, the intake openings 140 (140a to 140c) are disposed symmetrically about the central position Le in the crossing direction of the medium S.

In particular, in this example, the intake openings 140a, which is one of the three intake openings 140 positioned at the center, is disposed symmetrically about the central position Lc, and the intake openings 140b and 140c positioned at both sides are also disposed symmetrically about the central position Lc in the crossing direction.

In addition, in this example, the intake openings 140a in the central region in the crossing direction of the medium S has an opening area greater than those of the intake openings 140b and 140c at both sides. In other words, when the opening areas of the intake openings 140a to 140c are Aa to Ac, respectively, Aa>Ab, Ac is satisfied.

In addition, in this example, as illustrated in FIG. 6, the intake openings 140 are disposed within a region having a size less than or equal to a predetermined size w other than the size of a largest medium S that is used. In particular, in this example, w is the size of a smallest medium S that is used, for example, the size of a postcard.

As illustrated in FIG. 4, in this example, the intake openings 140 are disposed within an area of projection of the suction openings 111 and 112 when the suction openings 111 and 112 are viewed from the outside in the crossing direction of the medium S.

The number and layout of the intake openings 140 are not limited to those in FIG. 10A, and may be set as appropriate.

For example, as illustrated in FIG. 10B, plural intake openings 140 (four intake openings 140a to 140d in this example) may be disposed exclusively in the region Rc. The intake openings 140a and 140b, which are two of the intake openings 140 positioned at the center, have the same size and are disposed symmetrically about Lc, and the intake openings 140c and 140d positioned at both sides also have the same size and are disposed symmetrically about Lc. Opening areas Aa and Ab of the intake openings 140a and 140b are greater than opening areas Ac and Ad of the intake openings 140c and 140d.

As illustrated in FIG. 10C, one intake opening 140 may be disposed symmetrically about Lc in the region Rc.

### Thermal Insulation Structure of Fixing Device

In this example, a thermal insulation duct 150 is provided above the module housing 75 of the fixing belt module 61 of the fixing device 60 so that heat from the fixing device 60 does not affect the intermediate transfer body 30.

The overall shape of the thermal insulation duct 150 is flat and extends in the transport direction and the crossing direction of the medium S, and an air flow passage 151 through which air flows is formed in the thermal insulation duct 150. The thermal insulation duct 150 has a suction port (not illustrated) that opens toward the front of the image forming apparatus and through which air is sucked into the air flow passage 151; and an exhaust port (not illustrated) that opens toward the rear of the image forming apparatus and through which the air sucked in through the suction port is discharged from the air flow passage 151 to the outside of the apparatus.

The thermal insulation duct 150 may have any exhaust structure as appropriate, and the exhaust structure may, of course, be the exhaust structure (the communication duct 132 and the exhaust fan 130) of the exhaust mechanism 120 of the cooling mechanism 100 according to the present exemplary embodiment.

In this example, the region above the module housing 75 of the fixing belt module 61 of the fixing device 60 has a shielding member 160 extending downward at an end adjacent to the spatial region SR. The shielding member 160 provides a shield between the fixing device 60 and the second transfer device 50, and serves as a thermal insulation wall extending downward in the direction of gravity.

Thus, in this example, heat generated in the fixing device 60 is not easily transmitted to the second transfer device 50, and the increase in temperature around the second transfer device 50 is reduced.

### Operation of Image Forming Apparatus

A basic image forming process performed by the image forming apparatus in this example will now be described.

Referring to FIGS. 2 and 4, in the image forming apparatus, the image forming units 22 of the image forming engine 21 form toner images G of respective color components and transfer the images G to the intermediate transfer body 30 in the first transfer process.

After that, the images of the respective color components on the intermediate transfer body 30 are transferred to the medium S by the second transfer device 50 in the second transfer process.

After that, the medium S holding the images transferred thereto is transported along the transport belt 87 and output to the medium receiver after the images are fixed thereto by the fixing device 60.

When double-sided printing is performed, the medium S is reversed and returned to the second transfer region TR of the image forming engine 21 after the images are printed on one side thereof, and then the other side of the medium S is subjected to the image forming process. Subsequently, the medium S having images printed on both sides thereof is output to the medium receiver.

Thus, the image forming apparatus repeats the image forming process the number of cycles corresponding to the number of prints.

### Cooling Operation of Cooling Mechanism

The cooling operation of the cooling mechanism 100 will now be described.

Referring to FIG. 4, when the image forming apparatus repeats the image forming process as described above, the fixing heat from the fixing device 60 enters the spatial region SR and may cause an increase in the temperature around the second transfer device 50.

In this example, the cooling mechanism 100 performs a cooling process on the spatial region SR in this state.

In this example, the exhaust fan 130 of the exhaust mechanism 120 included in the cooling mechanism 100 is driven to rotate.

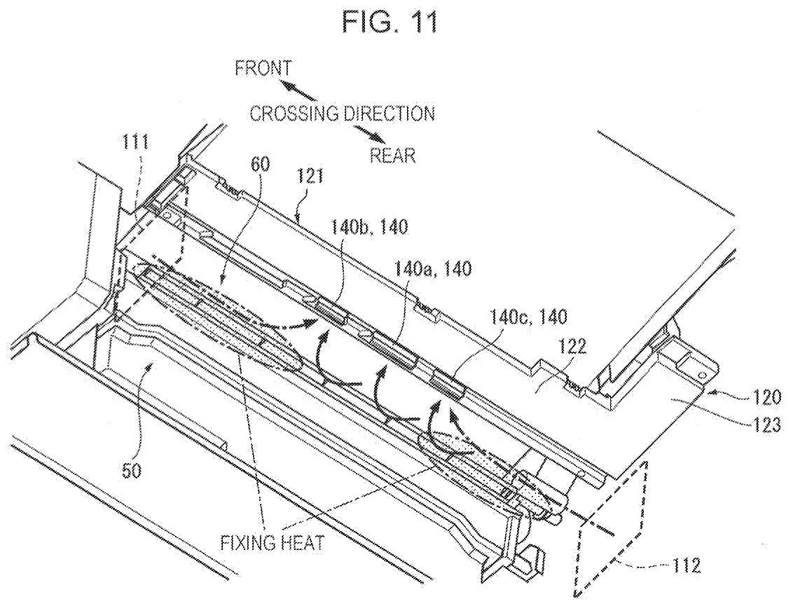

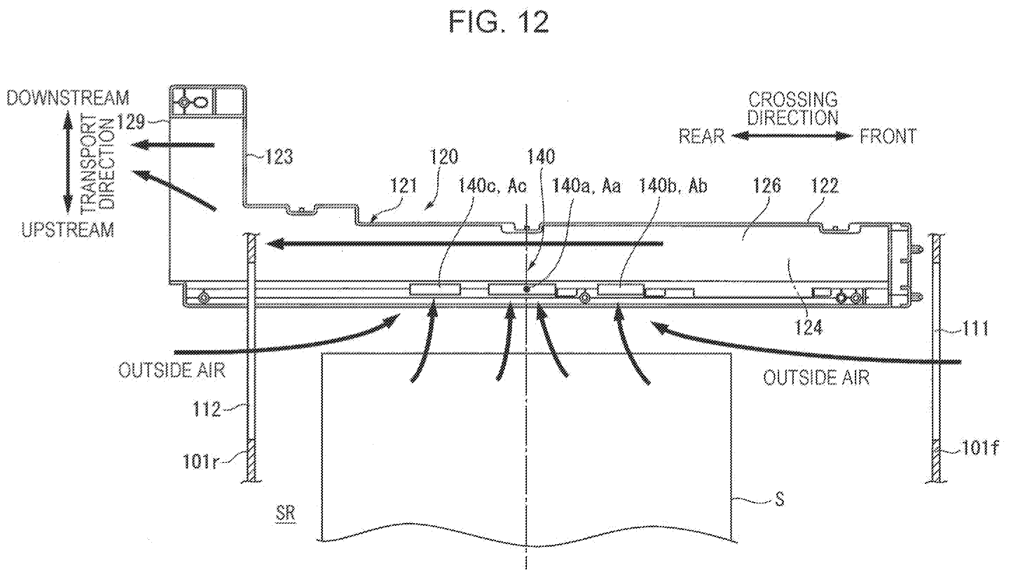

Accordingly, as illustrated in FIGS. 11 and 12, the air in the spatial region SR is drawn into the exhaust duct 121 through the intake openings 140.

Since the intake openings 140 (140a to 140c) are disposed in the central region in the crossing direction of the medium S, the air in the spatial region SR is drawn into the exhaust duct 121 basically through a substantially central region of the long section 122 of the exhaust duct 121.

Therefore, the outside air is sucked through the suction openings 111 and 112 at both sides in the crossing direction of the spatial region SR, and the outside air sucked into the spatial region SR flows transversely toward the intake openings 140 in the exhaust duct 121 in the spatial region SR.

In this state, the temperature increases more easily in sections of the spatial region SR through which the medium S does not pass than in a section of the spatial region SR through which the medium S passes. Since the outside air sucked through the suction openings 111 and 112 at both sides of the spatial region SR in the crossing direction flows through the sections in which the medium S does not pass, the air with the increased temperature in the spatial region SR is drawn into the exhaust duct 121 through the intake openings 140 together with the outside air.

The air drawn into the exhaust duct 121 flows through the air flow passage 124, enters the communication duct 132 through the communication port 129, and is discharged to the outside of the apparatus through the exhaust port 134 due to the suction effect produced by the exhaust fan 130.

In particular, in the present exemplary embodiment, the opening area of the intake opening 140a, which is one of the intake openings 140 that is disposed in the central region in the crossing direction of the medium S, is greater than the opening areas of the intake openings 140b and 140c. Therefore, the amount of air drawn in through the intake opening 140a is greater than the amount of air drawn in through the intake openings 140b and 140c.

Thus, a large portion of the outside air sucked through the suction openings 111 and 112 is drawn in through the intake openings 140a in the central region of the exhaust duct 121 in the crossing direction and, accordingly, the air flows transversely in the spatial region SR.

In addition, in this example, since the intake openings 140 in the exhaust duct 121 open downward in the direction of gravity, when the fixing heat from the fixing device 60 enters the spatial region SR. the flow of air whose temperature is increased due to the fixing heat is directly drawn into the exhaust duct 121 through the intake openings 140.

Thus, according to the cooling mechanism 100 of this example, the outside air is sucked from both sides in the crossing direction of the medium S and drawn into the exhaust duct 121 through the intake opening 140a in the central region in the crossing direction of the medium S, so that the air in the spatial region SR may be caused to flow through a large region at a low flow rate and that the air with the increased temperature may be discharged while being cooled with the outside air.

### Comparative Example

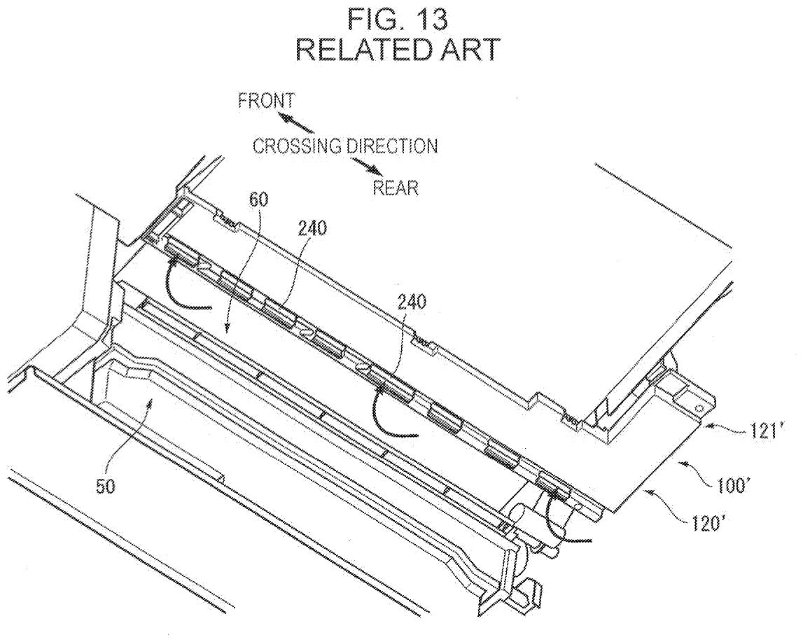

FIG. 13 is a schematic diagram of a cooling mechanism 100′ according to a comparative example.

In FIG. 13, the cooling mechanism 100′ has no suction openings 111 and 112 and includes an exhaust mechanism 120′ having plural intake openings 240 having the same size and arranged in the longitudinal direction of a long section 122 of an exhaust duct 121′ with substantially equal intervals therebetween.

According to the comparative example, since air is discharged evenly in the longitudinal direction of the exhaust duct 121′, the high-temperature air whose temperature has been increased in the spatial region SR is simply discharged, and low-temperature air cannot be efficiently drawn in. When the discharge flow rate is insufficient relative to the fixing heat, the temperature around the second transfer device 50 may increase due to transmission of the fixing heat.

### Second Exemplary Embodiment

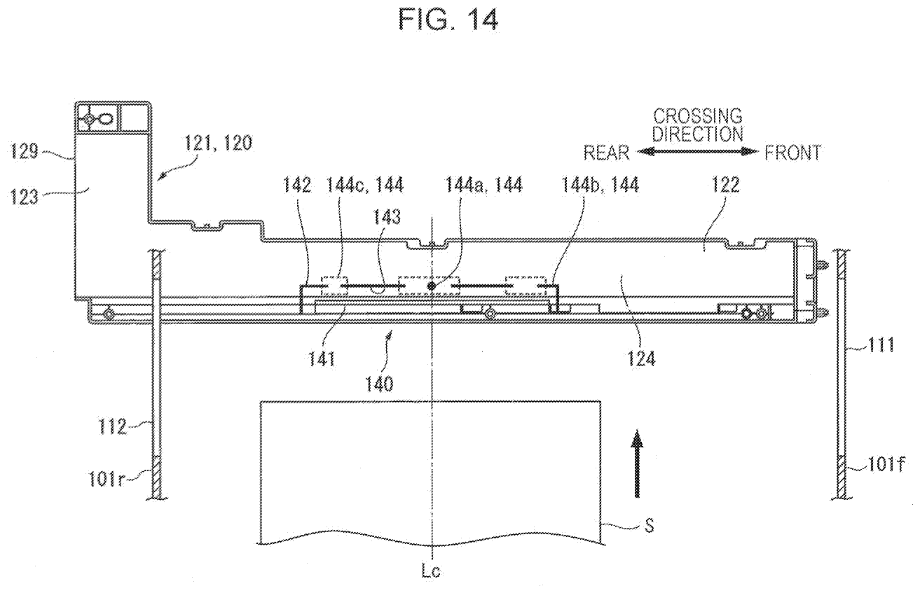

FIG. 14 illustrates a relevant part of a cooling mechanism 100 according to a second exemplary embodiment.

Referring to FIG. 14, substantially similarly to the first exemplary embodiment, the cooling mechanism 100 basically has a pair of suction openings 111 and 112 and includes an exhaust mechanism 120. However, the exhaust mechanism 120 has an intake opening 140 that differs from those in the first exemplary embodiment. Components similar to those in the first exemplary embodiment are denoted by the same reference signs as those in the first exemplary embodiment, and detailed description thereof will be omitted. This also applies to a third exemplary embodiment.

In this example, the intake opening 140 in the exhaust duct 121 is formed such that an opening portion 141 having the shape of a rectangular slit is formed in a lower surface portion 126 of a long section 122 in the central region in the crossing direction of the medium S. A recess 143 defined by a rib 142, which is a partitioning member having a U-shaped cross section, is formed around the opening portion 141 in an air flow passage 124 facing the opening portion 141. Plural restrictor openings 144 (specifically, 144a to 144c) are formed in a bottom portion of the recess 143 facing the opening portion 141 in the central region in the crossing direction of the medium S.

In this example, the restrictor opening 144a positioned in the central region in the crossing direction of the medium S has an opening area greater than those of the other restrictor openings 144b and 144c.

In this example, the intake opening 140 is formed such that air is drawn in through one opening portion 141, but the opening areas of the restrictor openings 144 (specifically, 144a to 144c) are adjusted such that the amount of air drawn in through the restrictor opening 144a at the center is greater than the amounts of air drawn in through the other restrictor openings 144b and 144c.

Therefore, also in the present exemplary embodiment, a cooling effect substantially similar to that of the cooling mechanism 100 according to the first exemplary embodiment may be obtained.

### Third Exemplary Embodiment

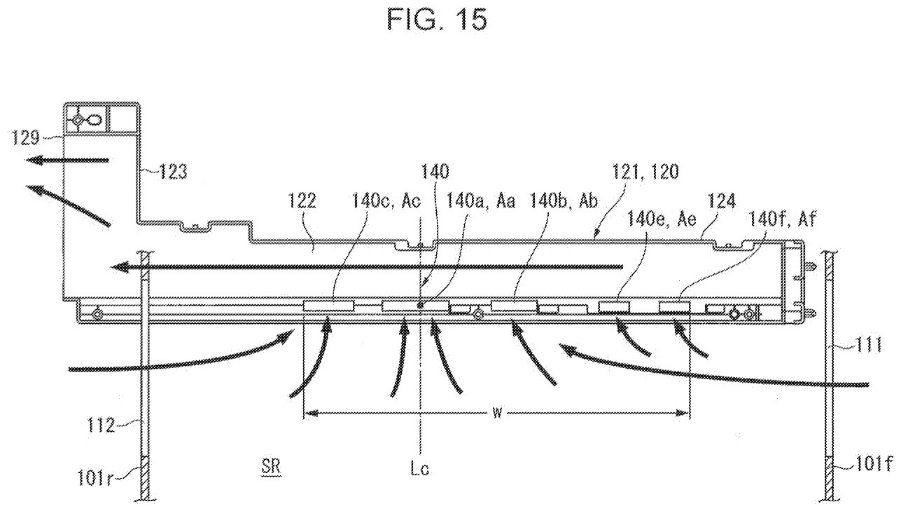

FIG. 15 illustrates a relevant part of a cooling mechanism 100 according to a third exemplary embodiment.

Referring to FIG. 15, substantially similarly to the first exemplary embodiment, the cooling mechanism 100 basically has a pair of suction openings 111 and 112 and includes an exhaust mechanism 120. However, the exhaust mechanism 120 has intake openings 140 that differ from those in the first exemplary embodiment.

In this example, similarly to the first exemplary embodiment, the exhaust duct 121 has three intake openings 140 (specifically, 140a to 140c) in a lower surface portion 126 of a long section 122 in the central region Rc (see FIG. 10) in the crossing direction of the medium S. The exhaust duct 121 also has plural intake openings 140 (specifically, 140e and 140f) in the lower surface portion 126 of the long section 122 in the region Re (see FIG. 10) adjacent to an end distant from the exhaust fan 130 (in other words, distant from the bent section 123) in the crossing direction of the medium S.

When opening areas of the intake openings 140 (specifically, 140a to 140c, 140e, and 140f) are Aa to Ac, Ae, and Af, respectively, Aa>Ab and Ac>Ae, Af are satisfied. According to the present exemplary embodiment, the intake openings 140 are formed in the long section 122 of the exhaust duct 121 not only in the region Rc in the central region in the crossing direction of the medium S but also in the region Re adjacent to one end in the crossing direction of the medium S, and are provided over a region having a size w greater than the size of the smallest medium S that is used. The ratio of the area occupied by the intake openings 140 (140a to 140c) in the region Rc is greater than that of the area occupied by the intake openings 140 (140c, 140f) in the region Re. Therefore, air is more easily drawn in through the intake openings 140 (140a to 140c) in the central region in the crossing direction of the medium S than through the other intake openings 140 (140e, 140f).

Also in the present exemplary embodiment, when the outside air is sucked through the suction openings 111 and 112 at both sides in the crossing direction of the medium S, the outside air sucked through the suction openings 111 and 112 is drawn in basically through the intake openings 140 (140a to 140c) in the central region of the exhaust duct 121 in the crossing direction of the medium S. Therefore, the outside air sucked through the suction openings 111 and 112 flows transversely in the spatial region SR toward the intake openings 140 (140a to 140c) in the central region of the exhaust duct 121 in the crossing direction of the medium S. and is discharged through the exhaust duct 121 while cooling the air whose temperature has been increased in the spatial region SR.

In this example, among the regions Re at the ends of the long section 122 of the exhaust duct 121 in the crossing direction of the medium S, the region Re adjacent to the exhaust fan 130 (closer to the bent section 123) has no intake openings 140. This is because if the intake openings 140 are formed in this region, the outside air sucked through the suction opening 112 adjacent to the exhaust fan 130 is immediately drawn in through the intake openings 140, and the outside air sucked through the suction opening 112 cannot be effectively used for cooling.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A image forming system including:
a transfer unit that transfers an image formed of a thermally fusible image-forming material to a medium that moves;
a thermal fixing unit disposed downstream of the transfer unit in a moving direction in which the medium moves, the thermal fixing unit fixing the image on the medium by at least heating the image; and
a cooling unit that cools a spatial region between the transfer unit and the thermal fixing unit,
wherein the cooling unit has suction openings through which outside air is taken into the spatial region between the transfer unit and the thermal fixing unit from both sides of the spatial region in a crossing direction crossing the moving direction of the medium, and
wherein the cooling unit includes an exhaust unit that draws in and discharges air in the spatial region such that an amount of air drawn in a central region in the crossing direction of the medium is greater than an amount of air drawn in regions adjacent to ends in the crossing direction of the medium.
   (((2)))

An image forming system including:
a transfer unit that transfers an image formed of a thermally fusible image-forming material to a medium that moves;
a thermal fixing unit disposed downstream of the transfer unit in a moving direction in which the medium moves, the thermal fixing unit fixing the image on the medium by at least heating the image; and
a cooling unit that cools a spatial region between the transfer unit and the thermal fixing unit,
wherein the cooling unit has suction openings through which outside air is taken into the spatial region between the transfer unit and the thermal fixing unit from both sides of the spatial region in a crossing direction crossing the moving direction of the medium, and
wherein the cooling unit includes an exhaust unit that draws in and discharges air in the spatial region such that an opening area in a central region in the crossing direction of the medium is greater than an opening area in regions adjacent to ends in the crossing direction of the medium.
   (((3)))

The image forming system according to (((1))) or (((2))),
wherein the exhaust unit includes an air flow unit extending in the crossing direction of the medium and a suction unit that sucks air in the air flow unit and discharges the air to outside, a portion of the air flow unit having an intake opening through which the air in the spatial region is drawn.
   (((4)))

The image forming system according to (((3))),
wherein the intake opening is disposed within an area of projection of the suction openings when the suction openings are viewed from the outside in the crossing direction of the medium.
   (((5)))

The image forming system according to (((3))) or (((4))),
wherein the intake opening opens toward a surface of the medium at a location above a path along which the medium moves.
   (((6)))

The image forming system according to any one of (((3))) to (((5))),
wherein the suction unit is disposed at one end of the air flow unit in the crossing direction of the medium, and
wherein, in a range from a center of the air flow unit in the crossing direction of the medium to the suction unit, the intake opening is provided in the central region in the crossing direction of the medium and is not provided in a region adjacent to the suction unit.
   (((7)))

The image forming system according to any one of (((3))) to (((5))),
wherein the intake opening is disposed within a region having a size less than or equal to a predetermined size other than a size of a largest medium that is used.
   (((8)))

The image forming system according to (((7))),
wherein the intake opening is disposed within a region having a size less than or equal to a size of a smallest medium that is used.
   (((9)))

The image forming system according to any one of (((3))) to (((8))),
wherein the intake opening includes a plurality of intake openings that are separate from each other, and one or more of the intake openings in the central region in the crossing direction of the medium have an opening area greater than an opening area of other intake opening or intake openings.
   (((10)))

The image forming system according to any one of (((3))) to (((8))).
wherein the intake opening is such that a flow passage area of the air flow unit is larger in the central region in the crossing direction of the medium than in other regions.

What is claimed is:

1. An image forming system comprising:
a transfer unit that transfers an image formed of a thermally fusible image-forming material to a medium that moves;
a thermal fixing unit disposed downstream of the transfer unit in a moving direction in which the medium moves, the thermal fixing unit fixing the image on the medium by at least heating the image; and
a cooling unit that cools a spatial region between the transfer unit and the thermal fixing unit,
wherein the cooling unit has suction openings through which outside air is taken into the spatial region between the transfer unit and the thermal fixing unit from both sides of the spatial region in a crossing direction crossing the moving direction of the medium, and
wherein the cooling unit includes an exhaust unit that draws in and discharges air in the spatial region such that an amount of air drawn in a central region in the crossing direction of the medium is greater than an amount of air drawn in regions adjacent to ends in the crossing direction of the medium.

2. An image forming system comprising:
a transfer unit that transfers an image formed of a thermally fusible image-forming material to a medium that moves;
a thermal fixing unit disposed downstream of the transfer unit in a moving direction in which the medium moves, the thermal fixing unit fixing the image on the medium by at least heating the image; and
a cooling unit that cools a spatial region between the transfer unit and the thermal fixing unit,
wherein the cooling unit has suction openings through which outside air is taken into the spatial region between the transfer unit and the thermal fixing unit from both sides of the spatial region in a crossing direction crossing the moving direction of the medium, and
wherein the cooling unit includes an exhaust unit that draws in and discharges air in the spatial region such that an opening area in a central region in the crossing direction of the medium is greater than an opening area in regions adjacent to ends in the crossing direction of the medium.

3. The image forming system according to claim 1,
wherein the exhaust unit includes an air flow unit extending in the crossing direction of the medium and a suction unit that sucks air in the air flow unit and discharges the air to outside, a portion of the air flow unit having an intake opening through which the air in the spatial region is drawn.

4. The image forming system according to claim 2,
wherein the exhaust unit includes an air flow unit extending in the crossing direction of the medium and a suction unit that sucks air in the air flow unit and discharges the air to outside, a portion of the air flow unit having an intake opening through which the air in the spatial region is drawn.

5. The image forming system according to claim 3,
wherein the intake opening is disposed within an area of projection of the suction openings when the suction openings are viewed from the outside in the crossing direction of the medium.

6. The image forming system according to claim 4,
wherein the intake opening is disposed within an area of projection of the suction openings when the suction openings are viewed from the outside in the crossing direction of the medium.

7. The image forming system according to claim 3,
wherein the intake opening opens toward a surface of the medium at a location above a path along which the medium moves.

8. The image forming system according to claim 4,
wherein the intake opening opens toward a surface of the medium at a location above a path along which the medium moves.

9. The image forming system according to claim 3,
wherein the suction unit is disposed at one end of the air flow unit in the crossing direction of the medium, and
wherein, in a range from a center of the air flow unit in the crossing direction of the medium to the suction unit, the intake opening is provided in the central region in the crossing direction of the medium and is not provided in a region adjacent to the suction unit.

10. The image forming system according to claim 4,
wherein the suction unit is disposed at one end of the air flow unit in the crossing direction of the medium, and
wherein, in a range from a center of the air flow unit in the crossing direction of the medium to the suction unit, the intake opening is provided in the central region in the crossing direction of the medium and is not provided in a region adjacent to the suction unit.

11. The image forming system according to claim 3,
wherein the intake opening is disposed within a region having a size less than or equal to a predetermined size other than a size of a largest medium that is used.

12. The image forming system according to claim 4,
wherein the intake opening is disposed within a region having a size less than or equal to a predetermined size other than a size of a largest medium that is used.

13. The image forming system according to claim 11,
wherein the intake opening is disposed within a region having a size less than or equal to a size of a smallest medium that is used.

14. The image forming system according to claim 12,
wherein the intake opening is disposed within a region having a size less than or equal to a size of a smallest medium that is used.

15. The image forming system according to claim 3,
wherein the intake opening comprises a plurality of intake openings that are separate from each other, and one or more of the intake openings in the central region in the crossing direction of the medium have an opening area greater than an opening area of other intake opening or intake openings.

16. The image forming system according to claim 4,
wherein the intake opening comprises a plurality of intake openings that are separate from each other, and one or more of the intake openings in the central region in the crossing direction of the medium have an opening area greater than an opening area of other intake opening or intake openings.

17. The image forming system according to claim 3,
wherein the intake opening is such that a flow passage area of the air flow unit is larger in the central region in the crossing direction of the medium than in other regions.

18. The image forming system according to claim 4,
wherein the intake opening is such that a flow passage area of the air flow unit is larger in the central region in the crossing direction of the medium than in other regions.

19. An image forming system comprising:
transfer means for transferring an image formed of a thermally fusible image-forming material to a medium that moves;
thermal fixing means disposed downstream of the transfer means in a moving direction in which the medium moves, the thermal fixing means fixing the image on the medium by at least heating the image; and
cooling means for cooling a spatial region between the transfer means and the thermal fixing means,
wherein the cooling means has suction openings through which outside air is taken into the spatial region between the transfer means and the thermal fixing means from both sides of the spatial region in a crossing direction crossing the moving direction of the medium, and
wherein the cooling means includes exhaust means for drawing in and discharging air in the spatial region such that an amount of air drawn in a central region in the crossing direction of the medium is greater than an amount of air drawn in regions adjacent to ends in the crossing direction of the medium.
